(19) United States
(12) Patent Application Publication
(10) Pub. No.: US 2018/0357655 A1
(43) Pub. Date: Dec. 13, 2018

(54) METHODS AND SYSTEMS OF IMPLEMENTING ONLINE DISPLAY OF DIGITAL-PROPERTY PRICING

(71) Applicants: Tim UNDERWOOD, Brooklyn, NY (US); JOHN MCDONALD, Brooklyn, NY (US)

(72) Inventors: Tim UNDERWOOD, Brooklyn, NY (US); JOHN MCDONALD, Brooklyn, NY (US)

(21) Appl. No.: 15/836,912

(22) Filed: Dec. 11, 2017

Related U.S. Application Data
(60) Provisional application No. 62/432,691, filed on Dec. 11, 2016.

(51) Int. Cl. G06Q 30/02; G06Q 10/08; G06Q 50/14

(52) U.S. Cl. CPC G06Q 30/0206; G06Q 50/14; G06Q 10/087; G06Q 30/0276

(57) ABSTRACT

In one aspect, a computerized method, useful for automatically creating and updating a digital display of a digital advertisement campaign includes the step of providing an inventory system. The inventory system comprises a set of inventory volume and prices available for sale. The computerized method includes the step of receiving a set of parameters for an advertisement campaign of the inventory from an online advertisement management entity. The computerized method includes the step of communicatively connecting a computer server system, of the online advertisement management entity, for implementing an online display of inventory pricing to the inventor system datastore. The computerized method includes the step of automatically generating a digital advertisement, with the computer server system

### CLAIM OF PRIORITY

This application claims priority to U.S. Provisional Patent Application No. 62432691, titled METHODS AND SYSTEMS OF IMPLEMENTING ONLINE DISPLAY OF AIRLINE-TICKET PRICING filed on 11 Dec. 2016. This application is hereby incorporated by reference in its entirety.

### FIELD OF THE INVENTION

This application relates generally to implementing the online display digital-property pricing.

### DESCRIPTION OF THE RELATED ART

Prior to invention of this application, airlines were forced to use a number of substandard processes for advertising an airline fare price online. The process could be performed manually. This can reduce the scale possible (since a human cannot monitor such vast quantities of data as well as a machine) and increase the risk of error given the delays caused by people manually performing the actions. Alternatively, prices could be inserted through some other digital means (e.g. a feed or a web scrape) but this did not allow for the necessary calculation of ‘reasonable availability’ (e.g. as required to meet governmental guidelines), any airline business rules or further intelligence for determining the price to display. These prior methods came with considerable risk of either misleading the consumer and/or advertising a non-optimal message.

### BRIEF SUMMARY OF THE INVENTION

In one aspect, computerized method, useful for automatically creating and updating a digital display of a digital advertisement campaign includes the step of providing an inventory system. The inventory system comprises a set of inventory volume and prices available for sale. The computerized method includes the step of receiving a set of parameters for an advertisement campaign of the inventory from an online advertisement management entity. The computerized method includes the step of profiling the inventory to generate a summary of the inventory that fit for purpose based on the set of parameters for the advertisement campaign. The computerized method includes the step of communicatively connecting a computer server system, of the online advertisement management entity, for implementing an online display of inventory pricing to the inventor system datastore. The computerized method includes the step of automatically generating a digital advertisement, with the computer server system, by: querying the inventory system for a current price of the inventory, determining a Lowest Compliant Price (LCP) for the inventory, defining a set of visually perceptible elements of the digital advertisement to include the current price of the inventory, that is above the LCP, and integrating the visually perceptible elements of the digital advertisement into an embeddable markup coded document that comprises the digital advertisement. The computerized method includes the step of communicating the digital advertisement to a web browser of a client-side computing device for display in a web page document or other digital property.

### BRIEF DESCRIPTION OF THE DRAWINGS

FIG. 1 illustrates an example system for implementing online display of airline-ticket pricing, according to some embodiments.

FIG. 2 depicts an exemplary computing system that can be configured to perform any one of the processes provided herein.

FIG. 3 is a block diagram of a sample-computing environment that can be utilized to implement various embodiments.

FIGS. 4A-B illustrate an example process 400 for digital advertisement campaign creation and update process, according to some embodiments.

FIG. 5 illustrates an example process for serving a request for a digital advertisement, as seen from the customer side, according to some embodiments.

FIG. 6 illustrates an example process for deriving LCP and communicating a populating value, according to some embodiments.

FIG. 7 illustrates an example screen shot of a webpage delivered by an airline-ticket pricing advertisement generation system and/or processes according to some embodiments.

FIG. 8 illustrates an example screen shot of a webpage delivered by an airline ticket pricing advertisement generation system and/or processes, according to some embodiments.

FIG. 9 illustrates an example screen shot of a webpage delivered by an airline ticket pricing advertisement generation system and/or processes, according to some embodiments.

FIG. 10 illustrates an example screen shot of a webpage delivered by an airline-ticket pricing advertisement generation system and/or processes, according to some embodiments.

FIG. 11 illustrates an example screen shot of a webpage delivered by an airline-ticket pricing advertisement generation system and/or processes, according to some embodiments.

FIG. 12 illustrates an example screen shot of a webpage delivered by an airline-ticket pricing advertisement generation system and/or processes, according to some embodiments.

The Figures described above are a representative set, and are not an exhaustive with respect to embodying the invention.

### DESCRIPTION

Disclosed are, a system, method, and article of implementing online display of digital-property pricing. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can be a set of routines, protocols and/or tools for building software applications. An API can specify how software components should interact. APIs can be used when programming graphical user interface (GUI) components.

Cloud computing can involve deploying groups of remote servers and/or software networks that allow centralized data storage and online access to computer services or resources. These groups of remote serves and/or software networks can be a collection of remote computing services.

Digital marketing can include the marketing of products or services using digital technologies, such as on the Internet, but also including mobile phones, audio advertisements, video advertisements, display advertising, and any other digital medium.

Digital property can be a web page document, digital advertisement unit, email, etc.

Global Distribution System (GDS) is a network that enables automated transactions between travel service providers (e.g. airlines, hotels, car rental companies, etc.) and travel agencies.

Mobile device can be a smart phone, tablet computer, wearable computer (e.g. a smart watch, a head-mounted display computing system, etc.). In one example, a mobile device can be a small computing device, typically small enough to be handheld having a display screen with touch input and/or a miniature keyboard.

Exemplary Systems

In some embodiments of a system for implementing online display of digital-property pricing, a software application which connects to an inventory database. The inventory database can be administered by an inventory owner and/or a third party. The inventory database can accept inventory from many sources. An example of a third-party inventory database is the GDS. The GDS can be used to house inventory for the travel sector. The GDS can be utilized by travel agents to search and book tickets.

The system for implementing online display of airline-ticket pricing can connect to the inventory database. The system can implement a sequence, of calls to poll the available inventory and associated prices. This information can then be used in specific campaigns. A campaign can be created by a user (e.g. to advertise flights which depart in a specific future timeframe, on a specific route, etc.). In another example, a campaign can be proactively created by the system in response to an observed need (e.g. a combination of available inventory and/or customer demand). Concurrently, the system can use various public datasets to understand a relevant competitive context. The system can determine whether a provider's prices are compelling compared to those on offer from other providers. This information can then be formed into a single dataset. Answers to example queries can then be determined, including, inter alia: what is the lowest legal price which can be advertised, and is there sufficient evidence to suggest advertising this price would be worthwhile, etc. The responses to these queries can then be combined to form the content of an advertisement. For example, the contents of an advertisement can include the price on offer and the details of the product (e.g. routes, locations, travel dates etc.). This information can then be made available through multiple outbound connections. It is noted that digital advertising can be in various formats and use various markup and/or other programming techniques/functions (e.g. HTML, CSS, AJAX, XML, etc.). Accordingly, the system for implementing online display of airline-ticket pricing can provide the resulting content in multiple forms including, inter alia: an API end point, a feed, an image file stored on a server, etc. This process can be repeated periodically at a pre-defined frequency (e.g. n-times per day, hourly, upon detection of a trigger condition, etc.). The process can then continue until terminated by a user.

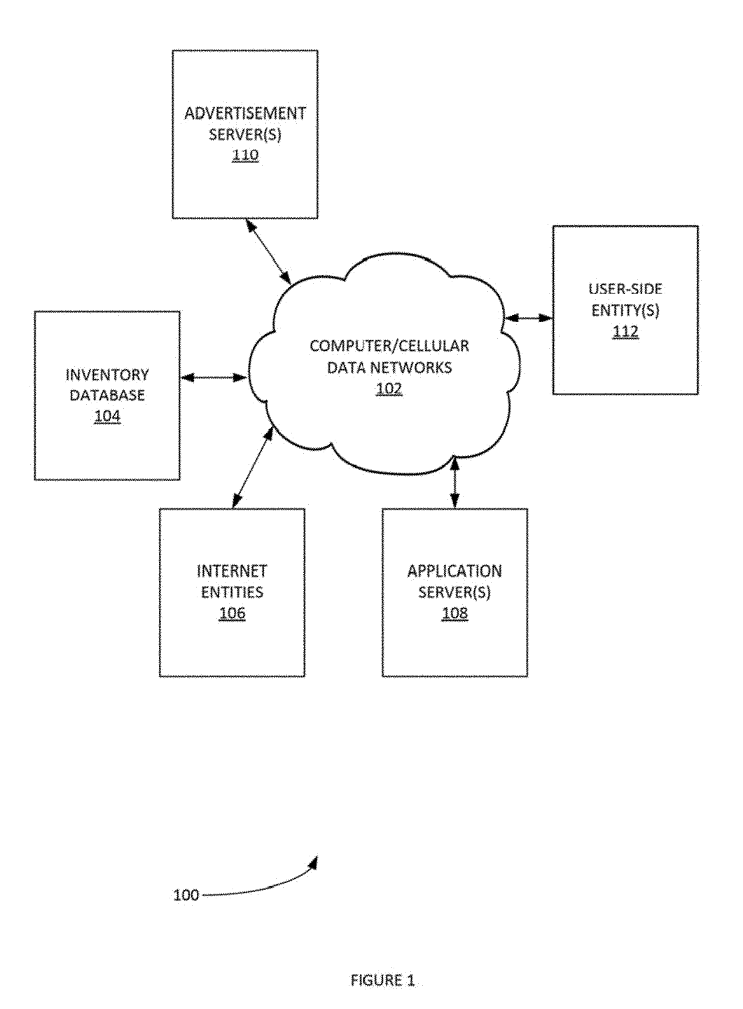

FIG. 1 illustrates an example system 100 for implementing online display of airline-ticket pricing, according to some embodiments. It is noted that system 100 can be adapted to implement the display of other digital properties (e.g. email, etc.) as well in other example embodiments. It is noted that, as used herein, the use case of airline tickets can be modified for other digital properties. For example, system 100 can be also be applied to any dynamic, variably priced inventory (e.g. form of ticket, real estate, commodities, etc.).

System 100 can include various entities. Said entities can communicate via computer/cellular data networks 102. System 100 can include an inventory database 104. Inventory database 104 can be a third-party system. Inventory database 104 can be maintained by an inventory owner (e.g. an airline, a hotelier, a cruise liner, a ticket retailer, etc.). Inventory database 104 can be an aggregated database (e.g. GDS, etc.). An aggregated database can be used by travel agents and/or online travel agents to search for and/or book tickets.

System 100 can include Internet entities 106. Internet entities 106 can provide public information to understand the competitive context of an advertiser. Competitive context can include, inter alia, prices from competitor airlines, hotels, etc. Competitive context can include signals of customer demand. It is noted that data available from these various systems can overlap.

System 100 can include an application server 108. Application server 108 can include a selection of specified databases. Advertisement server 108 can store the polled data. Advertisement server 108 can implement the relevant equations on the polled data. Advertisement server 108 can then produce and makes content available to a digital advertisement.

System 100 can include an advertisement server 110 Advertisement server 110 can be an external system. Advertisement server 110 can store various creative assets for a digital advertisement. Creative assets can include, inter alia: videos, images and/or text in various formats).

System 100 can include a user-side entity 112 User-side entity 112 can be a user device (e.g. a mobile device, a laptop, etc.) and/or web browser functionality. The digital advertisement can be loaded to user-side entity 112. For example, a web browser and/or mobile application can also be a video display (e.g. online television or similar) when enables by advertisement server 110. The content for the digital advertisement can be called. In one example, the digital advertisement can be called directly by the web browser. In another example, the digital advertisement can be called by advertisement server 110 and communicated to the user (e.g. user-side entity 112, etc.) as a reply to a user's search using an online search entity (e.g. an online search engine, a travel fare aggregator website and travel metasearch engine, etc.).

System 100 can define a Lowest Compliant Price (LCP). This can be done in various ways according to the preference of the end user. In one example, it is noted, a percentile equation can be utilized. For example, a governing jurisdiction may have a law that based on percentage availability (e.g. the LCP is the price of which you have ten percent (10%) or more of an entity's inventory at that price or lower, etc.). In another example, a static volume can be utilized. For example, a customer may request n-number of seats available at a specified price or lower. In another example, velocity/volume can be utilized. For example, by extended observation of inventory levels, system 100 can forecast the number of seats likely to be purchased in each booking class in the forthcoming time period. Accordingly, system 100 can understand both a booking velocity and the duration the digital advertisement is to be in market. System 100 can dynamically alter the volume of seats required to satisfy consumer demand and so satisfy United States Department of Transportation (DoT) regulations (and/or other application government entity regulations).

System 100 can automatically select a correct digital advertisement campaign based on customer metadata. It is noted that various brands' products may be tied to a specified location (e.g. an airport, etc.). Accordingly, a reasonable decision can be made on which route, or hotel to advertise based on a user's location.

System 100 can automatically create digital advertisement campaigns based on an inventory position. For example, flights and/or hotels are known to have ‘booking curves’ (e.g. the volume of seats/rooms expected to be sold at a certain time prior to take off/occupancy, etc.). System 100 can be set to absorb those booking curves and compare them to current inventory levels. In this way, system 100 can dynamically create digital advertisement campaigns that utilize marketing support.

System 100 can include various other functionalities useful for implementing the various processes and methods provided herein. For example, system 100 can include database management systems, search engines, machine learning/optimization systems, recommendation engines, email servers, text messaging systems, instant messaging system, natural language processing systems, etc.

In one example embodiments, system 100 can enable a user to enter the business rules they need to comply with (e.g. minimum/maximum price to display, availability of a seat on a given day, etc.). System 100 can then complete all other functions required to automatically generate a price to display (e.g. on a webpage, mobile device application, etc.). The associated outbound travel dates can be changed a specified number of times a day (e.g. as many as twenty-four (24) times a day in order to stay in compliance with the user's parameters) can also be automatically determined and provided. System 100 can compute a dynamic text in association to the price and outbound travel period. This dynamic text can include elements such as inter alias city, airport, travel dates in plain language etc.

In another example, a user may specify a geographic area, and system 100 can perform all other relevant functions. For example, an airline may provide the condition ‘advertise the best three prices from anywhere in California to anywhere else in Spain’ and system 100 can derive all airports relevant to the query and compute the lowest compliant price or prices to automatically display to the audience.

In another example, system 100 can determine the lowest price it can legally advertise, but proactively test prices above that point and monitor customer reaction. System 100 can continue to raise the price until such a point where it determines that customer reactions have dropped and determine this is the upper limit of willingness to pay for the product. System 100 can use various test webpages displaying the test prices and then implement various statistical-analysis functionalities to perform this process. System 100 can then report this information back to the airline (e.g. as an electronic message such as electronic mail, application message, via an API, etc.) so that it might be used in commercial strategy. It is noted, that system 100 can be applied outside of the airline industry and can apply to any use case with dynamic inventory levels. System 100 is can be internationalized and can display values in any currency.

System 100 can connect to an inventory system to profile all available inventory and then store a summary of that information which is made fit for purpose. However, in another example embodiments, system 100 can manage/maintain an inventory data store.

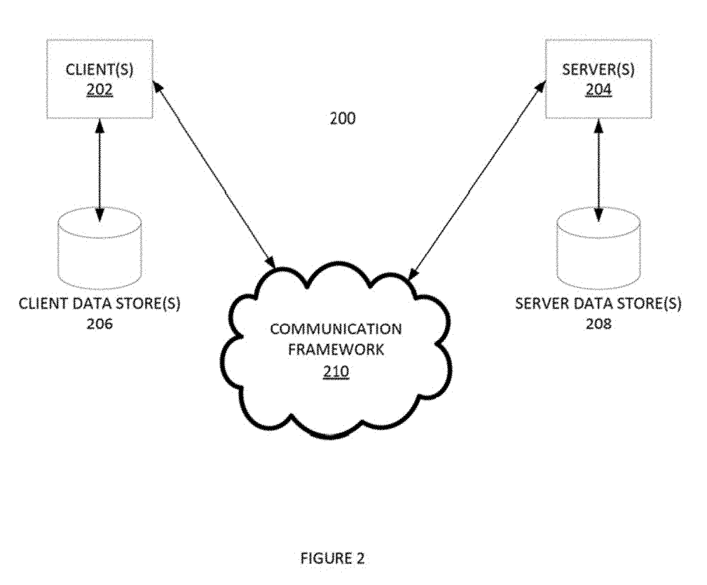

FIG. 2 is a block diagram of a sample-computing environment 200 that can be utilized to implement various embodiments. The system 200 further illustrates a system that includes one or more client(s) 202. The client(s) 202 can be hardware and/or software (e.g., threads, processes, computing devices). The system 200 also includes one or more server(s) 204. The server(s) 204 can also be hardware and/or software (e.g., threads, processes, computing devices). One possible communication between a client 202 and a server 204 may be in the form of a data packet adapted to be transmitted between two or more computer processes. The system 200 includes a communication framework 210 that can be employed to facilitate communications between the client(s) 202 and the server(s) 204. The client(s) 202 are connected to one or more client data store(s) 206 that can be employed to store information local to the client(s) 202. Similarly, the server(s) 204 are connected to one or more server data store(s) 208 that can be employed to store information local to the server(s) 204. In some embodiments, system 200 can instead be a collection of remote computing services constituting a cloud-computing platform.

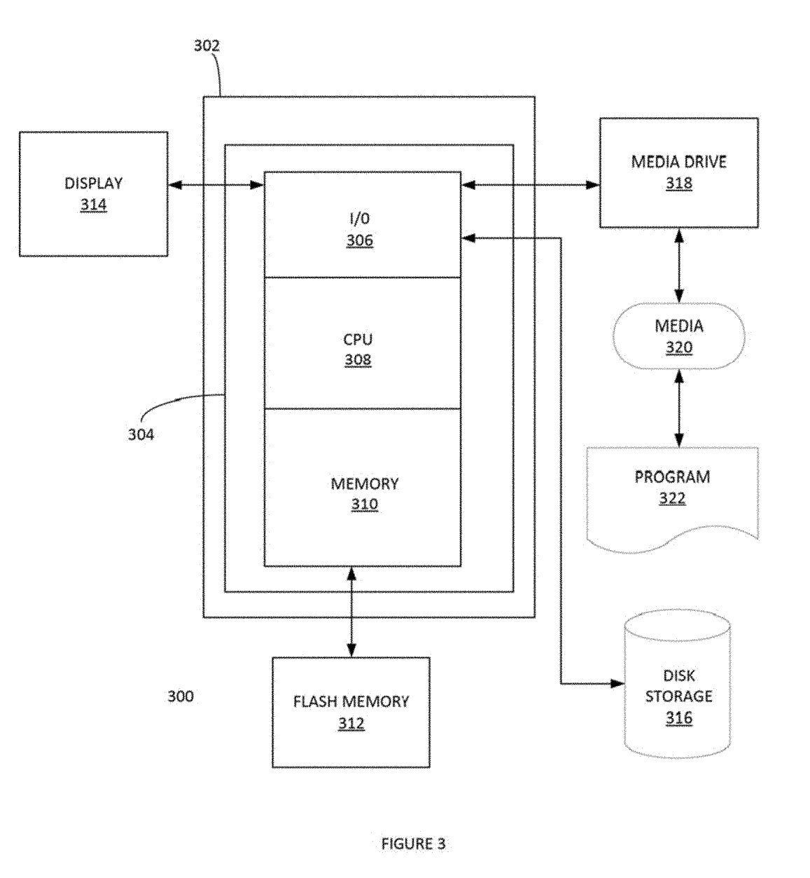

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that gray be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. Computing system 300 can communicate with other computing devices based on various computer communication protocols such a Bluetooth® (and/or other standards for exchanging data over short distances includes those using short-wavelength radio transmissions), USB, Ethernet, cellular, an ultrasonic local area communication protocol, etc.

Example Methods and Use Cases

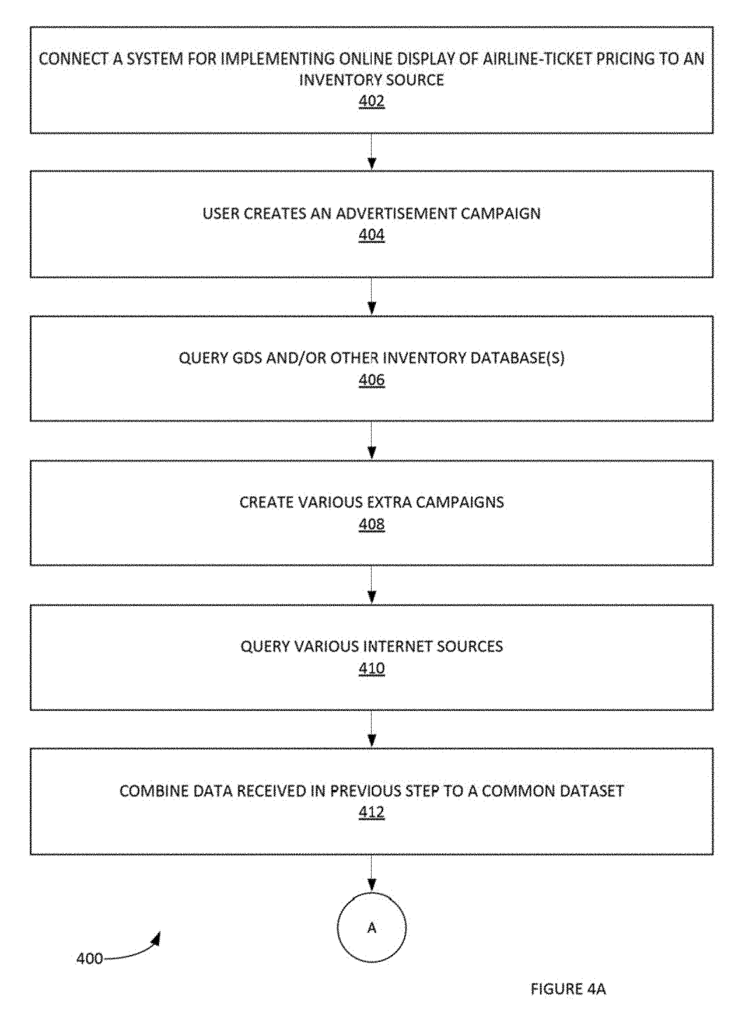

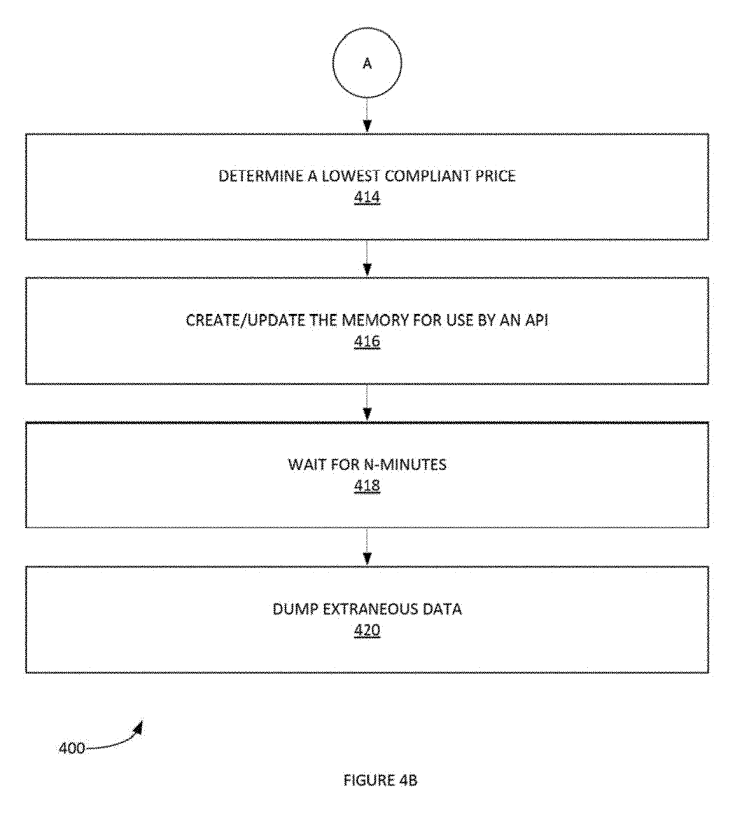

FIGS. 4A-B illustrate an example process 400 for digital advertisement campaign creation and update process, according to some embodiments. Process 400 can be implemented by the systems provided supra. In step 402, process 400 connect a system for implementing online display of airline-ticket pricing to an inventory source. The system can have the necessary credentials to connect to the inventory source's database.

In step 404, a user can create an advertisement campaign. The user can enter the parameters of the digital advertisement. The digital advertisement can include various elements such as, inter alia; a brand identity, a route (e.g. in case of airlines) and/or properties (e.g. in case of hotels), a date/travel window, the maximum/minimum prices the brand wishes to advertise, etc.

In step 406, process 400 can query a GDS and/or another inventory database(s). For example, the system can poll an inventory source to understand the volume and price of inventory available for sale.

In step 408, process 400 can create various extra campaigns. If process 400 notices that there is inventory which is not selling at the normal rate, it can create campaigns so as to satisfy a customer request. This can occur automatically according to a stored procedure. Various machine learning and/or optimization techniques can be utilized to implement step 408.

In step 410, process 400 can query various Internet sources. Process 400 can accept public datasets so to understand market competition. For example, knowledge of public datasets can be used to understand whether an advertising brand's prices are likely to be compelling to a customer, or if there are customers displaying interest in a certain product.

In step 412, process 400 can combine the data received in the previous step to a common dataset. For example, the data received in step 406-410 can comprise of various data types. These various data types can then be compiled into one or more specified format. These specified formats can be readable by the downstream elements of a system applying process 400 (e.g. system 100).

In step 414, process 400 can determine a Lowest Compliant Price (LCP) The LCP can use either a percentile and/or volume/velocity calculation. Process 400 can derive the lowest price the brand can legally advertise. This can be applied in the context of airline ticket price advertisements. In step 416, process 400 can validate against campaign criteria. For example, the derived LCP from step 414 can be compared to the criteria defined in step 404.

In step 418, process 400 can create/update the memory for use by an API, a feed, a set of image servers, etc. Various information (e.g. price and other meta data about the products being advertised) can be moved into ‘hot’ memory and made available by various means. These various means can be used to remain compatible with a multitude of marketing channels (e.g. banner advertisements, online search, social media platforms, email advertisements, digital video advertisements, television advertisements, etc.).

In step 420, process 400 can wait for n-minutes. Step 420 can be executed at the top of the hour and/or at another specified interval of time. In one example, fifteen minutes (15 min.) prior to the next update being executed, process 400 can be repeated from step 404.

In step 422, process 400 can dump extraneous data. For example, original responses from the GDS can be dropped. In step 424, process 400 can monitor API Usage. For example, an API can be monitored to determine a request volume and/or metadata related to the customer requesting the digital advertisement(s). Process 400 can manage inventory position and/or LCP components to a database. For purposes of reporting and creating an audit file, the observed inventory levels and the derived LCP can be stored in the database.

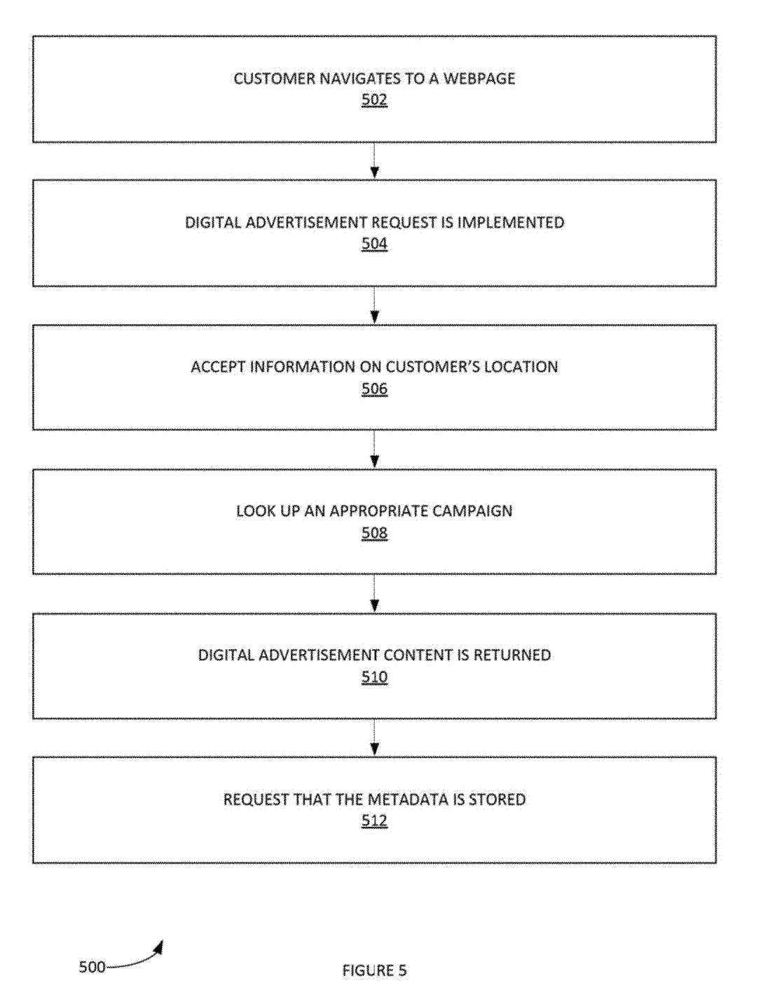

FIG. 5 illustrates an example process 500 for serving a request for a digital advertisement, as seen from the customer side, according to some embodiments. In step 502, customer can navigate to a webpage. For example, an Internet user can load a website (and/or video and/or audio advertisements) in a web browser and/or load the website in a mobile application. In another example, the Internet user can be shown a digital video advertisement. In step 504, a digital advertisement request can be implemented. For example, a tag (e.g. a short code snippet) can be activated and calls to digital advertisement system (e.g. online advertisement management system, etc.) such as those provided herein. In step 506, process 500 can accept information on customer's location. Location can be determined via various geolocation methods. During the request, certain information about the customer can be passed to process 500. This information can include attributes (e.g. location, etc.). Using these attributes process 500 can then decide a best product to advertise.

In step 508, process 500 can looks up an appropriate campaign. For example, using the attributes obtained from step 506, process 500 can decide which is the best product to advertise. In step 510, a digital advertisement content is returned. The digital advertisement content can be fed with the appropriate content based on the decisions in previous steps of process 500. In step 512, process 500 can request that the metadata is stored. It is noted that some customer metadata may be retained. The metadata can also be utilized to select digital advertisement content for the user.

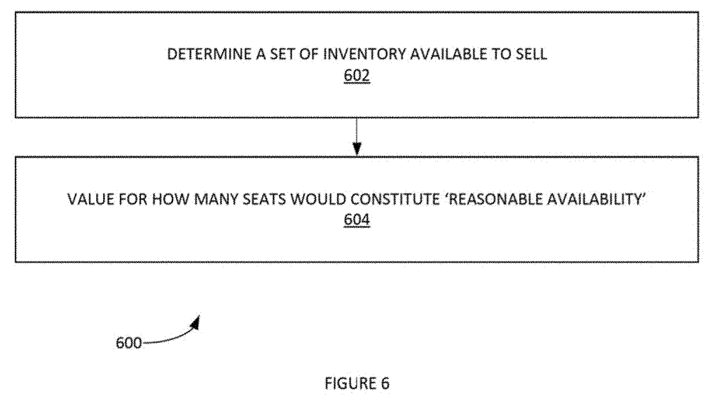

FIG. 6 illustrates an example process 600 for deriving LCP and communicating a populating value, according to some embodiments. Process 600 can derive the LCP of an airline can advertise without violating DoT regulations and/or other extant legal parameters. In step 602, process 600 can determine the inventory available to for sale (e.g. available airline tickets for a set of flights, etc.). In step 604, process 600 can calculate a value for how many seats would constitute ‘reasonable availability’. In some examples, step 604 can be derived in three manners, depending on user preference. In one example, the percentile can be determined. This can a percentage of the total seats available must be at the LCP price another example, the volume can be determined. This can be total of ‘n’ seats must be available at the LCP price or lower. In yet another example, a dynamic volume can be determined. The system can derive the number of seats required to satisfy demand according to observed sales velocity. For example, the following variables can be used to determine a dynamic volume, inter alia: the volume of sales in the previous hours, what volume of seats should be available at the LCP to satisfy the next hour's demand, etc. This value can be monitored and continually updated on a route-by-route and/or airport-by-airport basis to find the most appropriate value for the digital advertisement it relates to. It is noted that these equations can be updated as applicable regulations are modified and/or otherwise amended.

In order to support multiple ad campaigns, our system is required to support tens of millions of calls per month. It would be cost and time prohibitive to call to the GDS every time this request is made and so the GDS query is made once per hour, per campaign and then moved into high availability cached memory in order to provide a consistent sub-second response time.

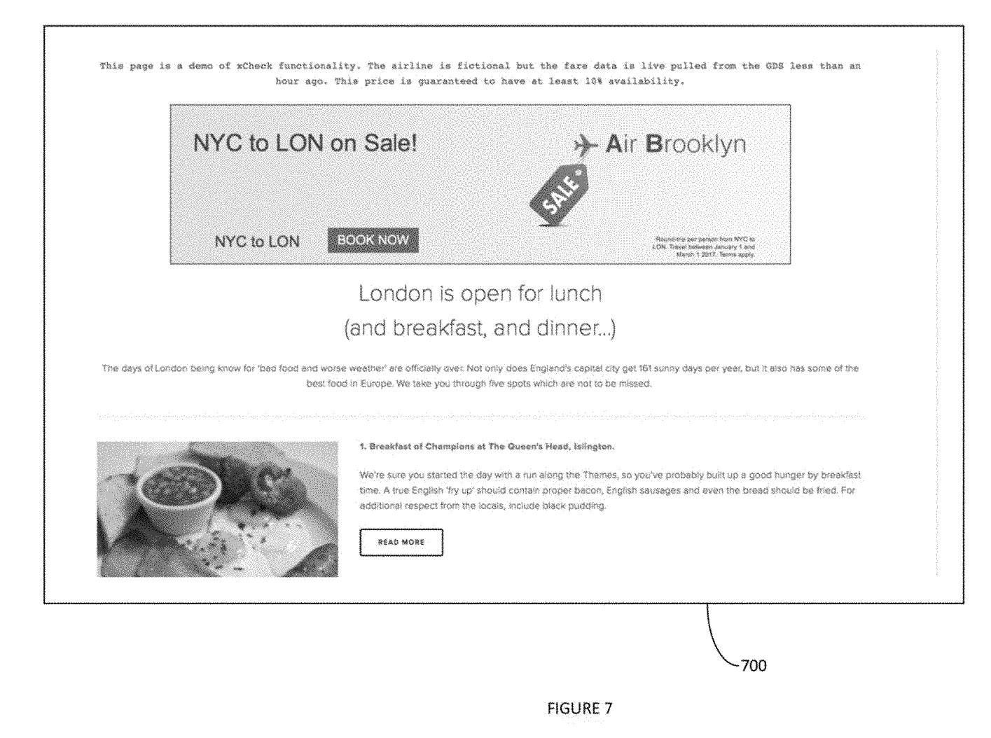

FIG. 7 illustrates an example screen shot of a webpage delivered by an airline-ticket pricing advertisement generation system and/or processes, according to some embodiments. In this state, the system has not yet run. The digital advertisement has been loaded, but because there has not yet been a response from the system. The system is unable to insert a live price into the creative as it has no source for the data which can be relied upon to be compliant. Hence this generic, default creative is shown (or no digital advertisement at all, depending on user preference).

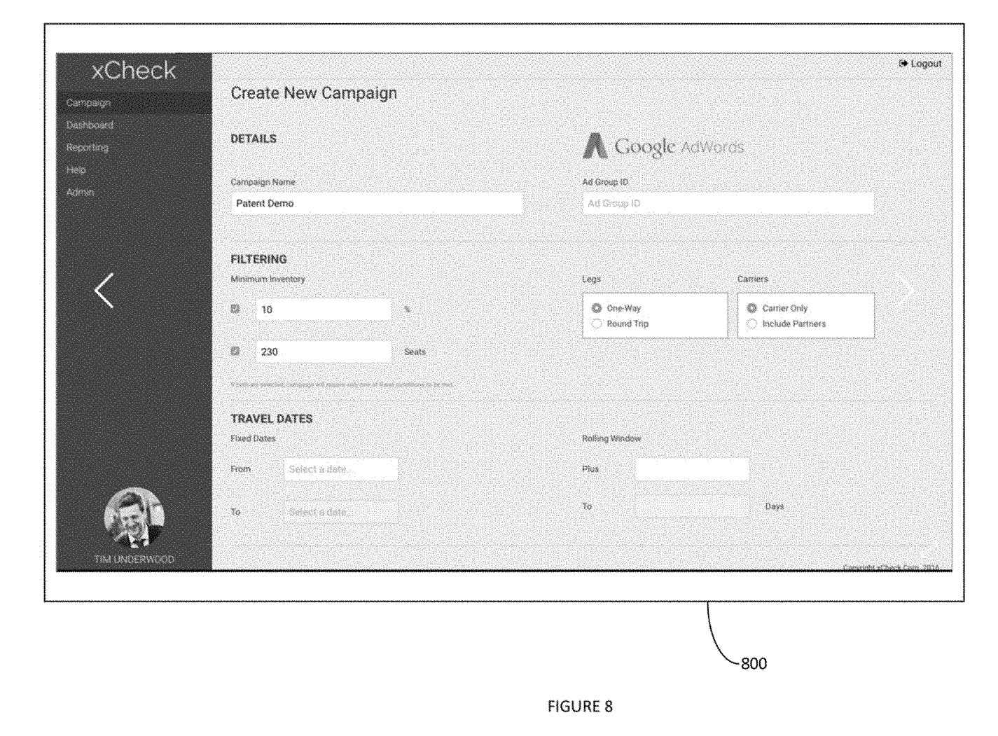

FIG. 8 illustrates an example screen shot of a webpage delivered by an airline-ticket pricing advertisement generation system and/or processes, according to some embodiments. In a separate location, a user opens the system's portal/webpage/application and navigates to a ‘Create New Campaign’ interface.

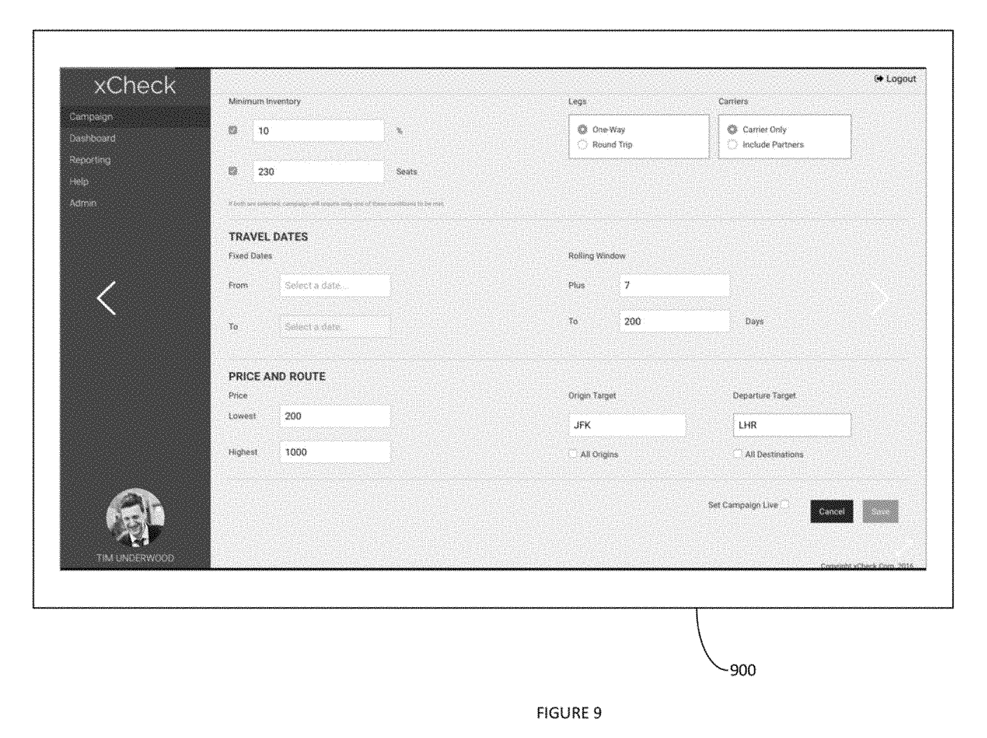

FIG. 9 illustrates an example screen shot of a webpage delivered by an airline-ticket pricing advertisement generation system and/or processes, according to some embodiments. The user enters the various variables used by the system to populate a campaign. These can include the percentage and/or volume of seats required for a digital advertisement to show. These can also include other details such as, inter alia: the travel window they wish to advertise, etc. In other example embodiments, these values can be created automatically according to sales velocity and/or available inventory respectively. A user can complete the required fields and saves the campaign. It is noted that the screen shots of FIGS. 8 and 9 can be combined into a single screen in some embodiments.

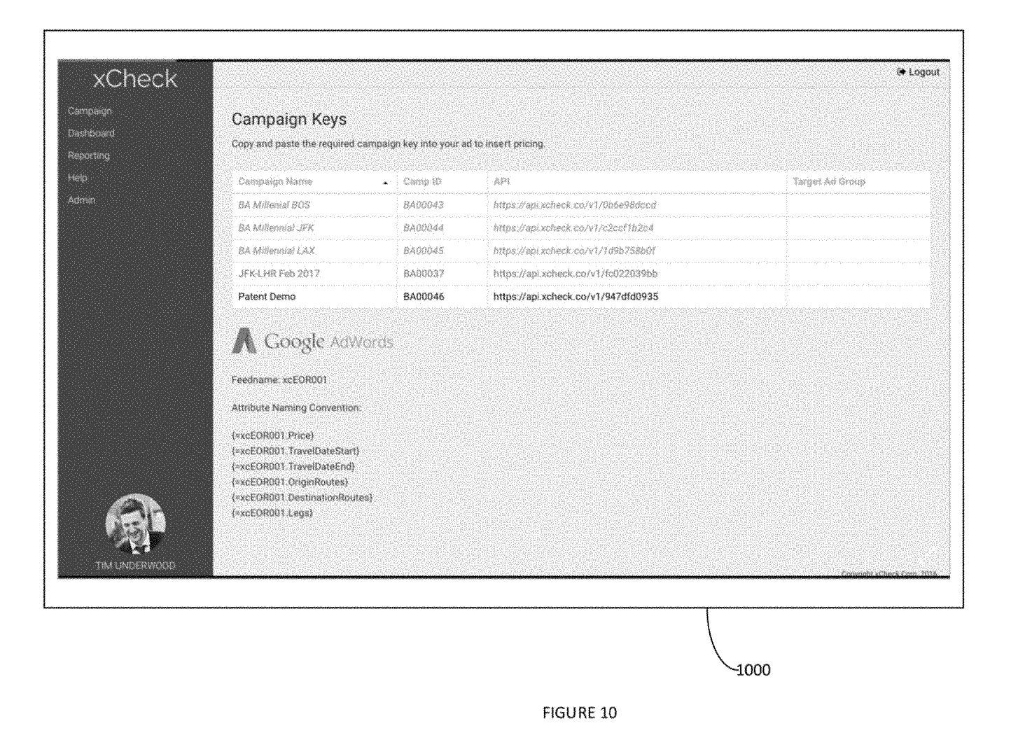

FIG. 10 illustrates an example screen shot of a webpage delivered by an airline ticket pricing advertisement generation system and/or processes, according to some embodiments. The system can instantly create a new API end-point for the specified campaign. The user can then send the API to the digital advertisement server for integration with their digital advertisement. The API can be called every time the digital advertisement loads (or periodically). It can be cached (e.g. per the specific needs of that technology). In parallel the GDS can be queried per the criteria previously entered. In one example, this can occur at 45 mins past the hour and then sent into memcache (e.g. with a memory cache, etc.) on the top of the hour. This memcache can be the memory used by the API to store the response it will send to the digital advertisement. This process is then repeated.

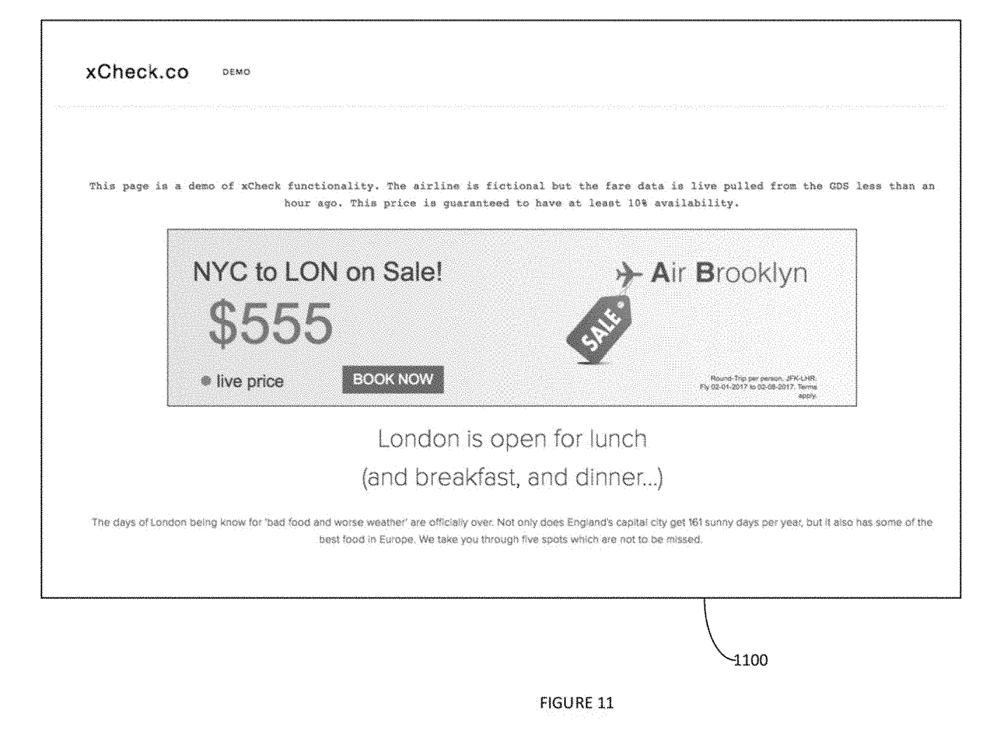

FIG. 11 illustrates an example screen shot of a webpage delivered by an airline-ticket pricing advertisement generation system and/or processes, according to some embodiments. The API is functional and returning prices. The next time the digital advertisement is called the content is changed. Now a price is inserted and communicated to the customer. Should the response from the GDS violate the criteria from a previous step, the API response can change to a format which instructs the ad server to serve the default digital advertisement. For example, this violation could be a lack of available inventory, or inventory at prices outside of the tolerable range set by the user.

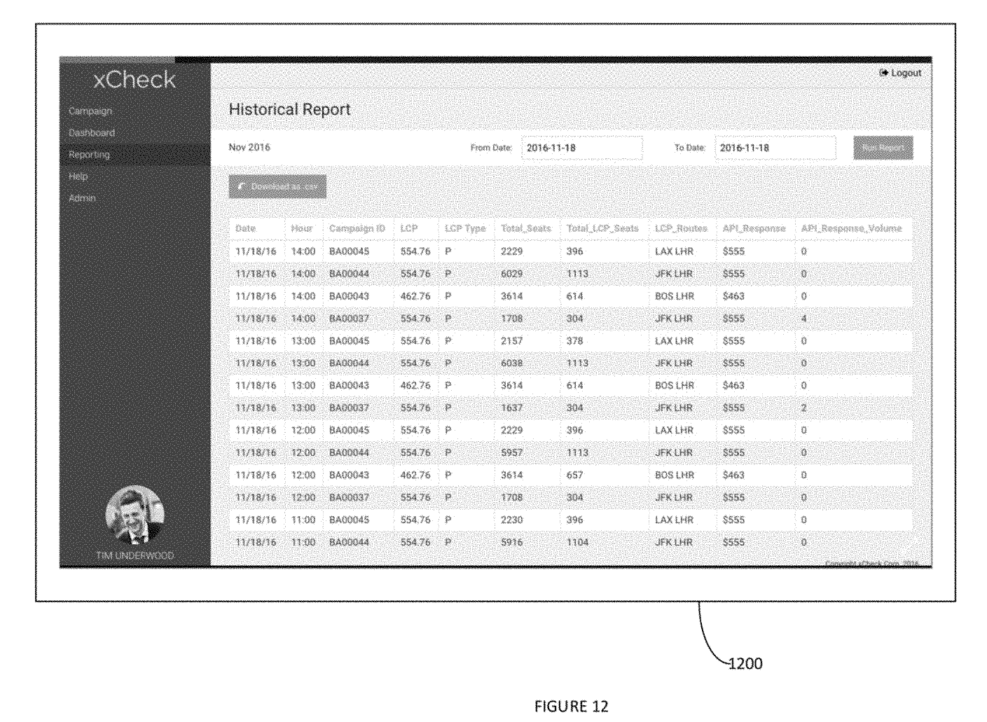

FIG. 12 illustrates an example screen shot of a webpage delivered by an airline-ticket pricing advertisement generation system and/or processes, according to some embodiments. Every hour, the system may log a number of elements regarding how the LCP was calculated (e.g. the total number of seats available, the LCP calculated, the volume of seats at the LCP, the value shown in responses and the number of times a response was requested, etc.). This reporting can be available via the present example screen shot. A user can filter responses by campaign and/or time period. The user can then view this on the screen and/or access a link to a downloadable file.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for automatically creating and updating a digital display of a digital advertisement campaign, comprising:
providing an inventory system, wherein the inventory system comprises a set of inventory volume and prices available for sale;
receiving a set of parameters or an advertisement campaign of the inventory from an online advertisement management entity;
communicatively connecting a computer server system, of the online advertisement management entity, for implementing an online display of inventory pricing to the inventor system datastore;
profiling the inventory to generate a summary of the inventory that fit for purpose based on the set of parameters for the advertisement campaign;
automatically generating a digital advertisement with the computer system, by:
querying the inventory system for a current price of the inventory,
determining a Lowest Compliant Price (LCP) for the inventory,
defining a set of visually perceptible elements of the digital advertisement to include the current price of the inventory that is above the LCP, and
integrating the visually perceptible elements of the digital advertisement into an embeddable markup coded document that comprises the digital advertisement; and
communicating the digital advertisement to a web browser of a client-side computing device for display in a web page document.

2. The computerized method of claim 1, wherein the inventory comprises a plurality of airline tickets related to a search for airline tickets received by an online search engine, and wherein the query relates to a set of airline flights which depart in a specific future timeframe and on a specific route.

3. The computerized method of claim 2, wherein the computer server system obtains the search for plurality of airline tickets received by an online search engine.

4. The computerized method of claim wherein the computer server system queries the inventory system for a current price of the plurality of airline tickets received by an online search engine.

5. The computerized method of claim 4, wherein the inventory datastore comprises a Global Distribution System (GDS) comprising a network that enables automated transactions between travel service providers and a travel agency.

6. The computerized method of claim 5, wherein the computer server system determines the LCP as a price of an airline ticket for which the inventory system has a specified integer number of an airline entity's inventory at an LCP price or lower.

7. The computerized method of claim 5, wherein the web page document comprises a tag associated with a display of the digital advertisement.

8. The computerized method of claim 7, wherein the tag triggers a call to the computer server system, of the online advertisement management entity to determine an appropriate content of the digital advertisement to automatically generate when the webpage document is accessed by the web browser of the client-side computing device.

9. The computerized method of claim 8, wherein the appropriate content of the digital advertisement is determined based on at least the geographical location of the client-side computing device.

10. The computerized method of claim 9, wherein the system proactively tests prices of inventory so to provide the user with a statistically reliable signal of price elasticity.
